(19) United States
(12) Patent Application Publication
(10) Pub. No.: US 2017/0282626 A1
(43) Pub. Date: Oct. 5, 2017

(54) Artistic uses for shrinkable plastic film, particularly shrink sleeve label film

(71) Applicant: Eloy Gonzalez, II, McAllen, TX (US)

(72) Inventor: Eloy Gonzalez, II, McAllen, TX (US)

(21) Appl. No.: 15/149,225

(22) Filed: May 9, 2016

Related U.S. Application Data
(60) Provisional application No. 62/157,972, filed on May 7, 2015.

(51) Int. Cl. B41M 5/035; B29C 65/00; B29C 65/48; B44C 5/04; B29C 65/10

(52) U.S. Cl. CPC B41M 5/0353; B44C 5/0469; B29C 65/10; B29C 65/4815; B29C 66/5326

(57) ABSTRACT

The present invention concerns a new use for shrinkable plastic film, particularly shrink sleeve label film, which can be directly anchored to a frame (which may or may not already have a canvas) to form a novel shrink film canvas. The inner and/or outer surface of said film can be printed and/or painted on, preferably heat shrunk to conform to the edges of said frame, and can be further treated by methods and means known to the art, to serve as a painting on a shrink film canvas. If only the inner part of the canvas is printed or painted on, the outer surface of the shrink film can serve as a protective layer, while also providing a glossy sheen normally achieved through the application of a varnish medium. The painted or unpainted plastic film, can further be treated as necessary to further alter and/or enhance the appearance of the image it carries, and need not be limited to canvas art work, and instead be used as a singular product, such as, for example, gift wrapping material, or in combination with other products, such as in a kit.

### CROSS REFERENCE TO RELATED APPLICATIONS

This application claims the benefit of provisional patent application Ser. No. 62/157,972, filed by the present inventor on 2015 May 07.

Canvases for painting have traditionally been constructed from cotton or linen. The process of painting on them has, in most cases, created a texture on the surface where the paint has been more thinly or thickly applied. And in order for the painting to last and to look more aesthetically-pleasing, a layer of transparent acrylic is often applied to the surface as a spray.

Shrink sleeve labels have a protective sheen which is provided by a film, usually composed of plastic film, particularly shrink sleeve label film, which usually comes between 25 and 50 microns thick, and which can be printed on and thermoformed. The image created for shrink sleeve labels is usually printed, either digitally or by using printmaking methods such as screen- or block-printing, onto the inside surface (and in some cases, the outside surface) of the plastic film. The finished material is then formed into a the shape of a cylinder, solvent- or heat-sealed, and then the cylindrical shrink sleeve label can be applied to a commercial object, such as, for example, a bottled beverage or cleansing solution. Heat, usually from a heat gun or heat shrink tunnel, causes the printed sleeve label to shrink down to the size of the object within it, and upon cooling, the final product is a circumferentially-labeled container.

To the best of the present inventor's knowledge, shrink film, particularly shrink sleeve label film, oil and acrylic painting, and canvas art technologies have historically not been combined into one.

My invention is a new use for shrinkable plastic film, particularly shrink sleeve label film, preferred to be 25 to 50 microns thick, but can be thinner or thicker as desired, constructed of, but not limited to, PET (polyethylene terephthalate), PETG (polyethylene terephthalate glycol), PVC (polyvinyl chloride), OPS (oriented polystyrene), or PLA (polylactic acid), or any combination thereof. The film is preferred to be transparent, but it can be any texture, color, hue, shade, or opacity, in order to alter, distort, or enhance the image it will receive. It can be directly anchored to a frame—which can be of any shape, size, color, texture, or dimensions, and be made of any suitable material such as metal, plastic or wood—to form a shrink film canvas. The film of said shrink film canvas will essentially wrap around the sides of the frame and to the back (like the cotton or linen material of a traditional canvas does), where it can be supported and secured further by use of a seaming solvent or combination of materials and methods, such as, but not limited to, NMP (N-Methyl-2-pyrrolidone) or dioxolane, fasteners, staples, glue/adhesives, and/or heat seaming. Or, an image can be printed using traditional printing or digital printing, painted, or transferred, to one side or both sides of the film. The method of image creation onto the surface of the film can be from one or a variety of methods and techniques, and the present invention is not limited to just one. If the painted film is anchored onto a frame, it can be heat shrunk to conform to the edges of said frame, and serve as a painting on a plastic film canvas, and may in fact need little, if any, anchoring material, as the shrunken plastic may have enough stiffness to anchor itself to the frame. If only the inner side of the film (facing the frame) receives an image, then on the outer side of the film (facing away from the frame) the image will appear as a mirror-image and flat uniform work of art, with the same quality and overall likeness as that of a commercial shrink sleeve label. Any need for further shrinking of the plastic film can be accomplished through application of heat, such as from a heat gun. Both sides of the frame can receive painted and/or unpainted film. The painted or unpainted plastic film can be applied to an already constructed canvas, allowing the cotton or linen cloth to provide further structural support and/or a white background, which too can be printed, painted, or have an image transferred onto its surface using one or a variety of methods and techniques not limited by the examples provided herein this provisional patent application. The painted or unpainted plastic film need not be limited to canvas art work, and, can be used and/or marketed as a single product, such as, for example, gift wrapping material.

For review, the basic steps to creating this invention are as follows: The film is painted and anchored to a frame, or, the film is anchored to a frame, and then painted. Heat is used to shrink the painted or unpainted film to form a final heat-shrunk film product, which is essentially a painting on a plastic film canvas support medium. Said plastic film is preferred to be shrink sleeve label film.

The drawings illustrate the construction and use of the invention.

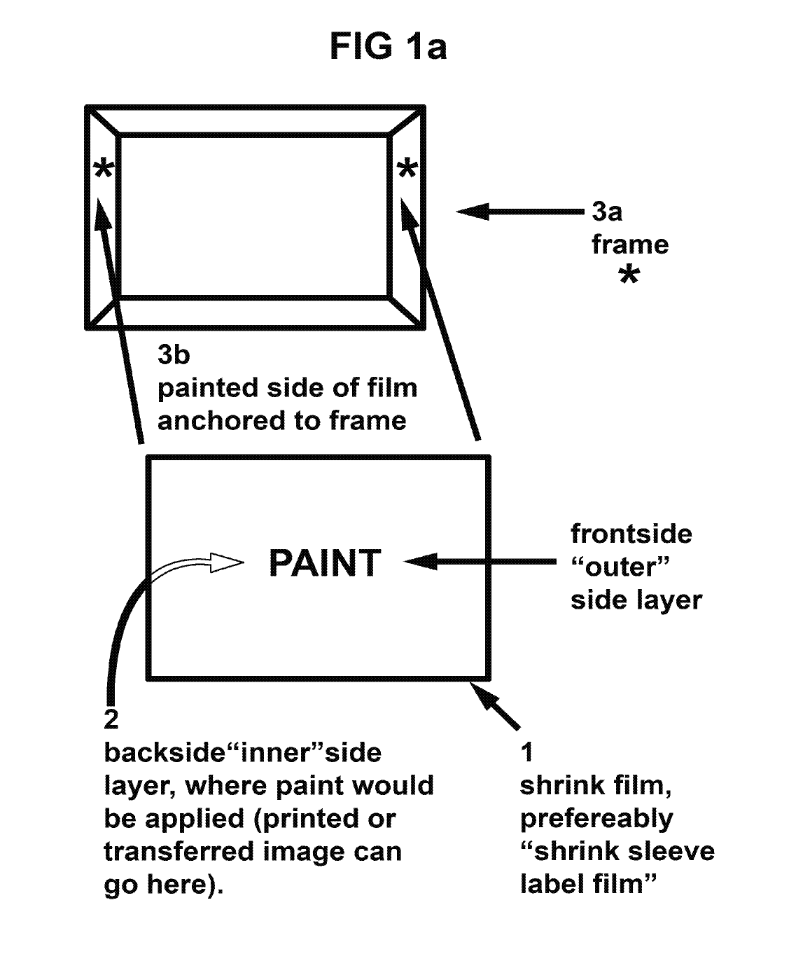

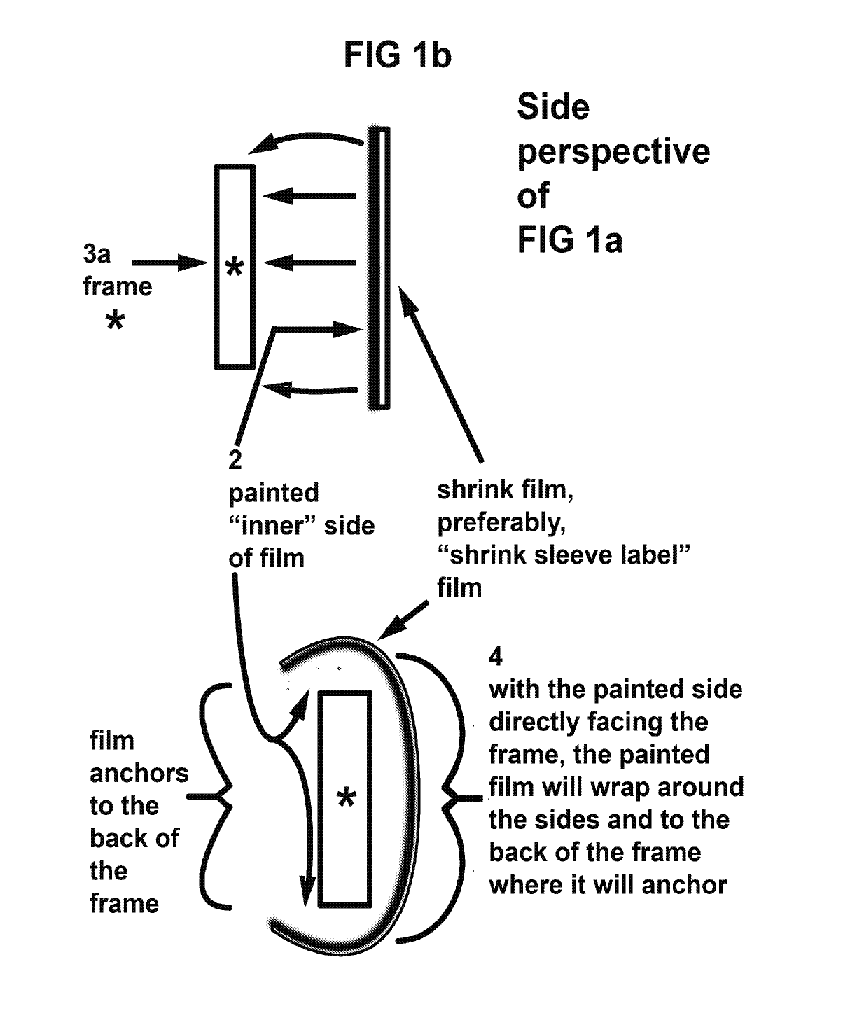

FIG. 1a illustrates that shrink film, preferably shrink sleeve label film, would be used as the support medium for paint (1).

FIG 1b illustrates a side perspective of FIG 1a. Paint, which can be one or a variety of colors, would be applied to the “inner” side layer of the film (2) Instead of paint, an image can be printed or transferred to the “inner” side layer of the film. Once dried, the painted film would anchor to the frame (3a) by essentially wrapping around the sides of the frame and to the back (like the cotton or linen material of a traditional canvas does), with the painted side directly facing said frame (3b).

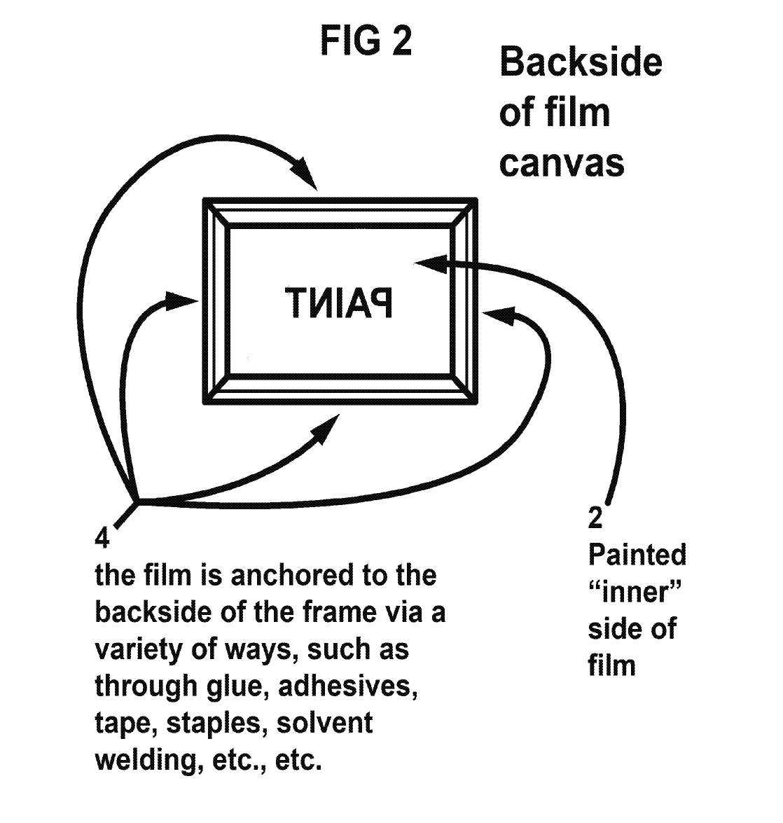

FIG. 2 illustrates the anchoring on the back of the frame could be accomplished by one or a variety of methods, such as, and not limited to, the stiffness of the shrunken film itself, glue, adhesives, tape, staples, solvent welding, etc., etc. (4).

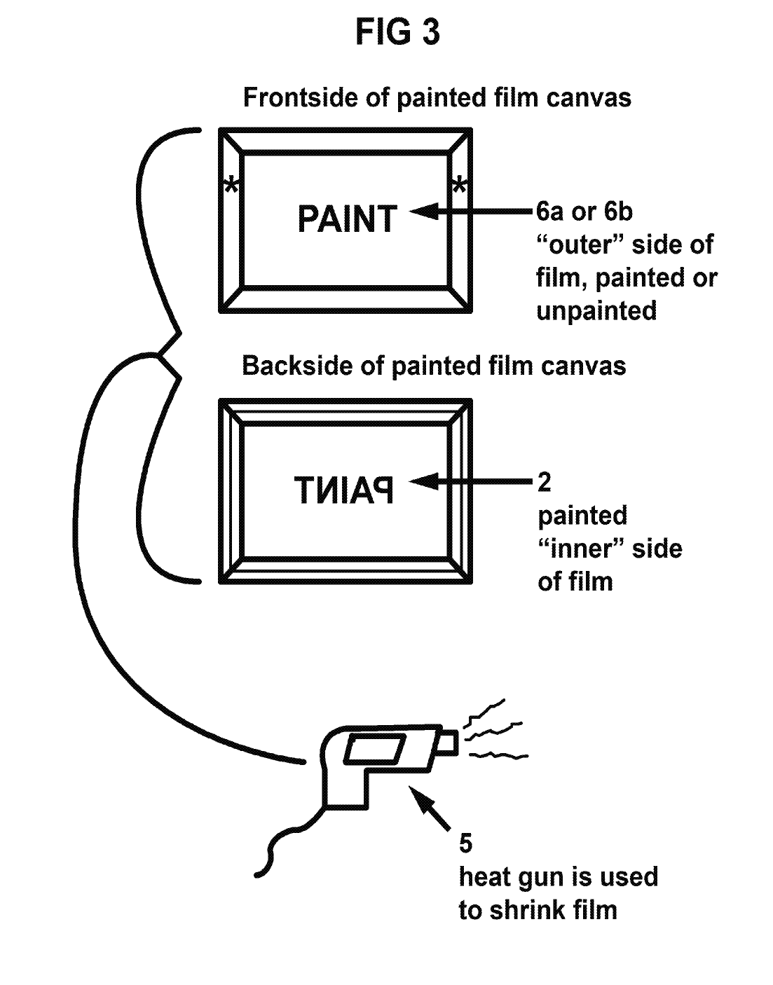

FIG. 3 illustrates that once all paint and solvent are dried, a heat gun would be applied in order to cause the painted film to aesthetically shrink to a minimal size, which is generally the size of the frame, so that it may grasp said frame snugly and tightly to form the final painted film canvas (5). In this way, although the inner side of the film may have a rough texture due to the applied paint being uneven, the outer side or sides of the film will appear and feel flat, with the overall image and the final painted film canvas having a uniform look, similar in scope to that of a commercial shrink sleeve label (6a). If, instead, it is the outer side of the film that will receive paint, it may have a rough texture due to the applied paint being uneven, and so this variant of the invention will appear as a standard painting, but will use plastic film, instead of cotton or linen, as the canvas support medium to create the final painted film canvas (6b).

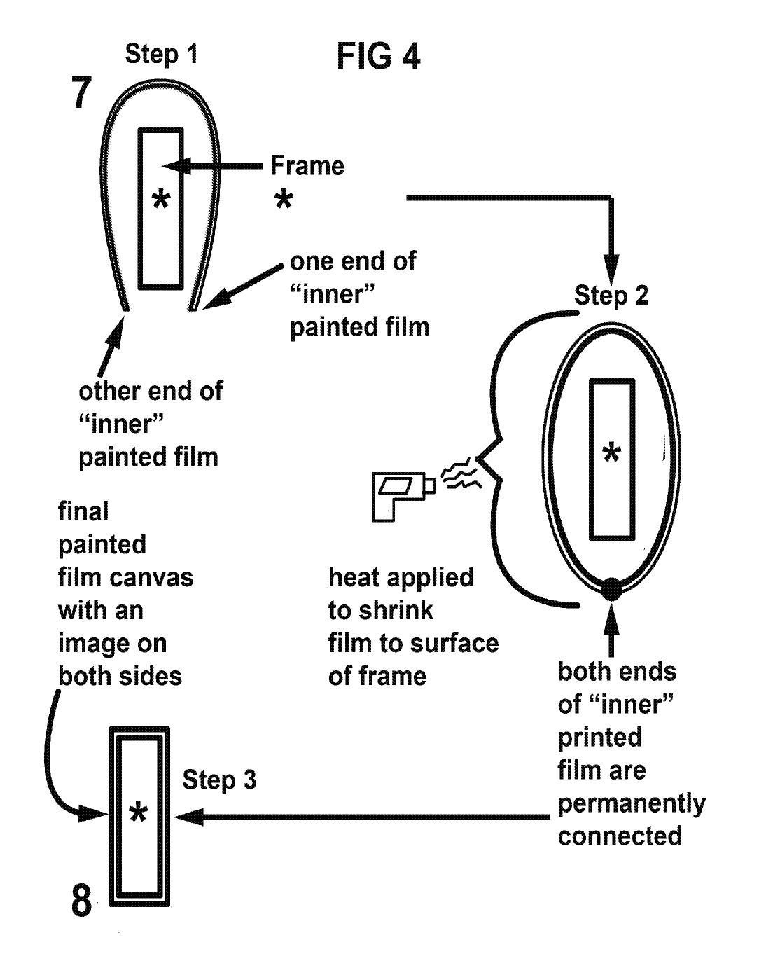

FIG. 4 illustrates a variation (7) whereby Step 1 will have the inner painted shrink film anchored to the frame from the top down. Step 2 will have the ends of the inner painted film seamed shut at the bottom of the frame, and Step 3 will have the whole of the painted shrink film/frame exposed to heat (preferably from a heat gun) so that the inner painted shrink film will shrink down to minimal size to snugly and tightly fit the surface of the frame. In this way, the final painted film canvas will have an image on both the front and back side of it consistent with the description and qualities of the final products described in this provisional patent application (8).

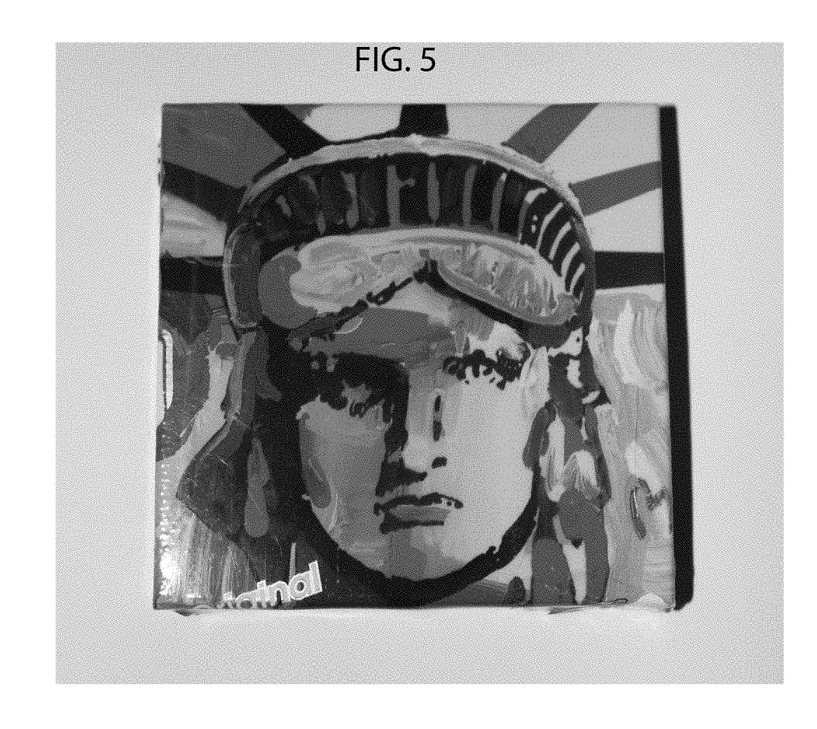

FIG. 5 is a color photograph of the front side of a final painted film canvas created from a mini-canvas and an Arizona tea shrink sleeve label with a Statue of Liberty facial image. The mini-canvas cotton or linen cover was kept and the shrink sleeve label was used as the painted shrink film medium. The shrink sleeve label was anchored properly to the back of the mini-canvas with staples, and once the image was centered correctly, heat from a heat gun was applied and the shrink sleeve label shrunk down to the minimal size of the mini-canvas surface. The staples and excess shrink sleeve label plastic from the back of the canvas were removed. The final product was the desired and expected painted film canvas.

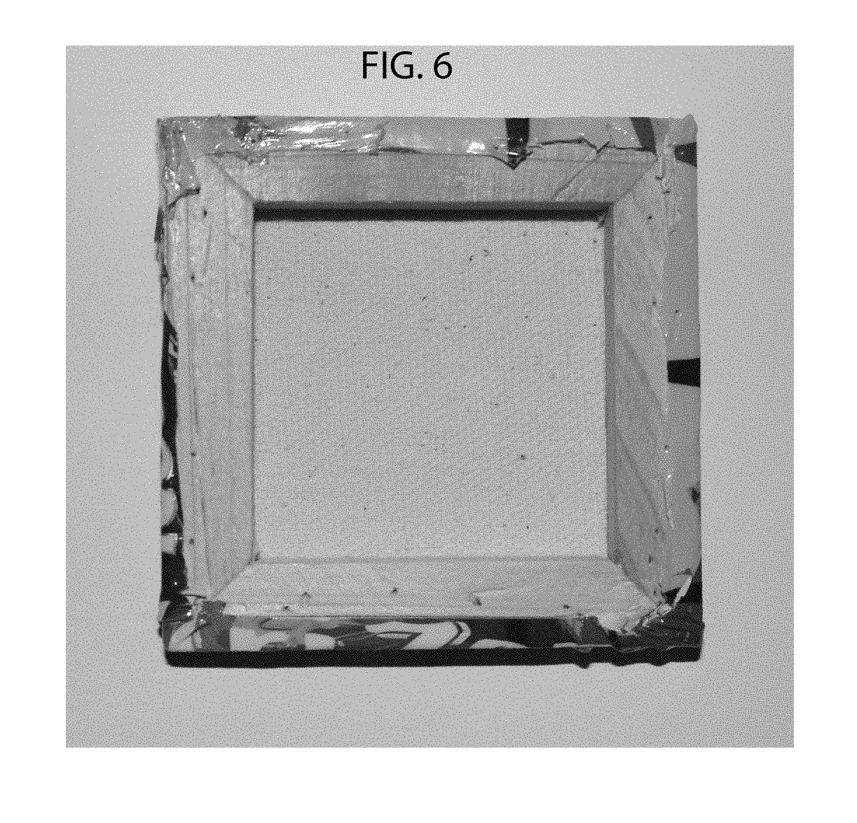

FIG. 6 is a color photograph of the back side of the aforementioned final painted film canvas created from a mini-canvas and an Arizona tea shrink sleeve label with a Statue of Liberty facial image.

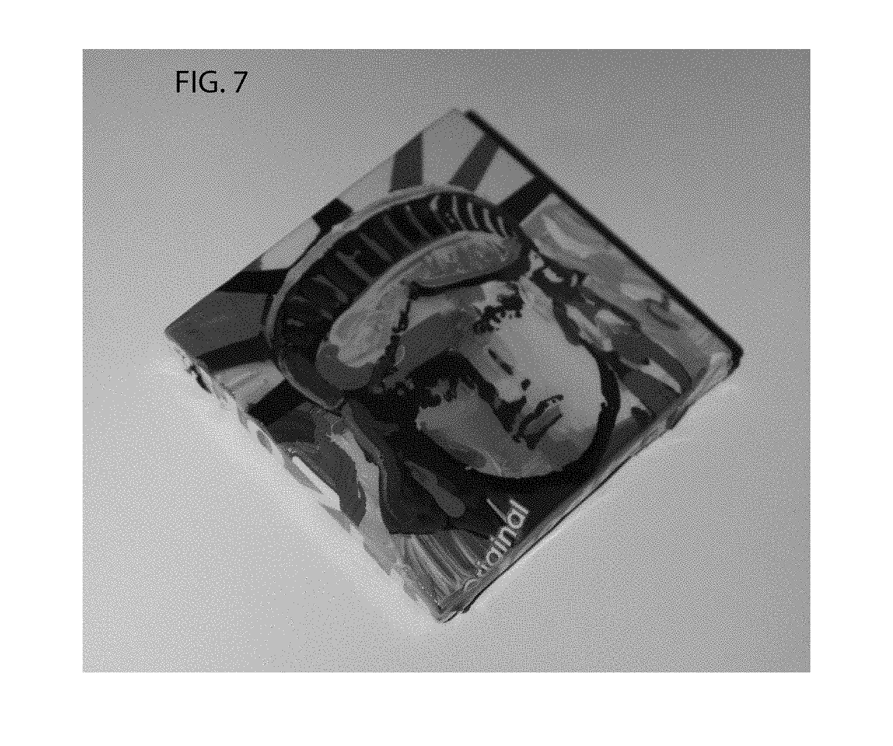

FIG. 7 is a color photograph of lower-angle side view of the aforementioned final painted film canvas created from a mini-canvas and an Arizona tea shrink sleeve label with a Statue of Liberty facial image. In this photo, two of the sides of the final painted film canvas, are visible.

The more detailed steps of this invention are not required to occur linearly, and can be arranged as desired, and the materials and methods used can be varied but still remain within the spirit and scope of the invention. For example, the shrink film could be heat treated and shrunk before being painted or printed on.

As an example of an all-inclusive kit, the frame (with or without a cotton or linen cover), PETG film, and, if necessary, NMP solvent, could be sold for creating paintings on shrinkable plastic film. Or, the PETG film and NMP solvent, could be sold as a kit for creating gift wrapping paper.

Further treatment of the painted or printed product can occur by methods and means known to the art. For example, by the application of varnish or matte medium.

As regards the wish of the present inventor to cover every aspect of said and present invention as thoroughly as possible, the following excerpt, proficiently describing said present inventor's wish, is included with this patent application.

Taken from U.S. Pat. No. 4,739,116:

“Although this invention has been described with respect to specific embodiments, the details thereof are not to be construed as limitations, for it will be apparent that various equivalents, changes and modifications may be resorted to without departing from the spirit and scope thereof and it is understood that such equivalent embodiments are intended to be included herein.”

I claim:

1. A new use for shrinkable plastic film, particularly shrink sleeve label film, comprising, in combination, said shrink film anchored to a frame (which may or may not already have a canvas), printed or painted on one or both sides, which may be shrunk by heat to fit the dimensions of said frame, and which may be further treated by methods and means known to the art, in order to produce a new and novel artistic canvas medium; essentially, a new kind of painting.

2. A new use for shrinkable plastic film, particularly shrink sleeve label film, comprising said shrink film as a single product to be marketed individually for the new use described in claim 1.

3. A new use for shrinkable plastic film, particularly shrink sleeve label film, comprising said shrink film, which may or may not be printed or painted on, for use as gift wrapping paper.

4. A new use for shrinkable plastic film, particularly shrink sleeve label film, comprising one or more of the items described in claim 1, in combination as a kit.
